(19) United States
(12) Patent Application Publication
(10) Pub. No.: US 2018/0027597 A1
(43) Pub. Date: Jan. 25, 2018

(54) METHOD AND APPARATUS FOR UPLINK TRANSMISSION IN AN UNLICENSED BAND

(71) Applicant: LG ELECTRONICS INC., Seoul (KR)

(72) Inventors: Joonkui AHN, Seoul (KR); Kijun KIM, Seoul (KR); Hanjun PARK, Seoul (KR); Seonwook KIM, Seoul (KR)

(73) Assignee: LG ELECTRONICS INC., Seoul (KR)

(21) Appl. No.: 15/545,472

(22) PCT Filed: Jan. 20, 2016
(86) PCT No.: PCT/KR2016/000577

§ 371 Date: Jul. 21, 2017

Related U.S. Application Data
(60) Provisional application No. 62/106,216, filed on Jan. 22, 2015.
(60) Provisional application No. 62/204,451, filed on Aug. 13, 2015.

(51) Int. Cl. H04W 74/08; H04W 74/00; H04W 84/12

(52) U.S. Cl. CPC H04W 74/0883; H04W 74/0875; H04W 74/004; H04W 84/12

(57) ABSTRACT

A method and apparatus for uplink transmission in an unlicensed band are provided. The apparatus performs CCA from a start of the CCA in an unlicensed band to confirm whether a channel is idle or not. If the channel is idle or not, the apparatus transmits uplink data.

### BACKGROUND OF THE INVENTION

### Field of the Invention

The present invention relates to wireless communication, and more particularly, to a method and apparatus for uplink transmission in an unlicensed band in a wireless communication system.

### Related Art

With the explosive increase in mobile data traffic in recent years, a service provider has utilized a wireless local area network (WLAN) to distribute the data traffic. Since the WLAN uses an unlicensed band, the service provider can address a demand for a significant amount of data without the cost of an additional frequency. However, there is a problem in that an interference phenomenon becomes serious due to a competitive WLAN installation between the providers, quality of service (QoS) cannot be guaranteed when there are many users, and mobility cannot be supported. As one of methods for compensating this, a long term evolution (LTE) service in the unlicensed band is emerged.

LTE in unlicensed spectrum (LTE-U) or licensed-assisted access using LTE (LAA) is a technique in which an LTE licensed band is used as an anchor to combine a licensed band and an unlicensed band by the use of carrier aggregation (CA). A user equipment (UE) first accesses a network in the licensed band. A base station (BS) may offload traffic of the licensed band to the unlicensed band by combining the licensed band and the unlicensed band according to a situation.

The LTE-U may extend an advantage of LTE to the unlicensed band to provide improved mobility, security, and communication quality, and may increase a throughput since the LTE has higher frequency efficiency than the legacy radio access technique.

Unlike the licensed band in which exclusive utilization is guaranteed, the unlicensed band is shared with various radio access techniques such as the WLAN. Therefore, each communication node acquires a channel to be used in the unlicensed band in a contention-based manner, and this is called a carrier sense multiple access with collision avoidance (CSMA/CA). Each communication node must perform channel sensing before transmitting a signal to confirm whether a channel is idle, and this is called clear channel assessment (CCA).

Since various wireless access techniques perform the CCA in the unlicensed band, there is a need for a method capable of reducing an interference.

### SUMMARY OF THE INVENTION

The present invention provides a method and device for uplink transmission in an unlicensed band.

In an aspect, a method for uplink transmission in an unlicensed band is provided. The method includes determining, by a wireless device, a clear channel assessment (CCA) start within a CCA window to perform CCA in the unlicensed band, confirming, by the wireless device, whether a channel is idle by performing the CCA from the CCA start in the unlicensed band, and transmitting, by the wireless device, uplink data if the channel is idle.

The uplink data may be transmitted based on a reference timing determined in accordance with an uplink timing in a licensed band.

The method may further incudes transmitting a reservation signal for occupying the channel until the uplink data is transmitted after confirming that the channel is idle.

The wireless device may perform the CCA during a CCA duration from the CCA start to confirm whether the channel is idle.

The CCA duration may comprise a plurality of CCA slots, and the wireless device may determine that the channel is idle if the channel is idle at first and last CCA slots among the plurality of CCA slots.

In another aspect, a device in a wireless communication system includes a transceiver configured to transmit and receive a radio signal, and a processor operatively coupled to the transceiver. The processor is configured to determine a clear channel assessment (CCA) start within a CCA window to perform CCA in the unlicensed band, confirm whether a channel is idle by performing the CCA from the CCA start in the unlicensed band, and transmit uplink data through the transceiver if the channel is idle.

In an environment where various communication protocols co-exist in an unlicensed band, an interference between devices can be decreased, and a channel access occasion can be equally provided.

### BRIEF DESCRIPTION OF THE DRAWINGS

FIG. 1 shows an example of a long term evolution (LTE) service using an unlicensed band.

FIG. 2 shows an example of uplink (UL) transmission in 3rd generation partnership project (3GPP) LTE.

FIG. 3 shows an example of UL transmission in an unlicensed band.

FIG. 4 shows another example of UL transmission in an unlicensed band.

FIG. 5 shows UL transmission according to an embodiment of the present invention.

FIG. 6 shows UL transmission according to another embodiment of the present invention.

FIG. 7 shows UL transmission according to another embodiment of the present invention.

FIG. 8 shows UL transmission according to another embodiment of the present invention.

FIG. 9 shows signal transmission according to an embodiment of the present invention.

FIG. 10 is a block diagram showing a wireless communication system according to an embodiment of the present invention.

### DESCRIPTION OF EXEMPLARY EMBODIMENTS

A wireless device may be fixed or mobile, and may be referred to as another terminology, such as a user equipment (UE), a mobile station (MS), a mobile terminal (MT), a user terminal (UT), a subscriber station (SS), a personal digital assistant (PDA), a wireless modem, a handheld device, etc. The wireless device may also be a device supporting only data communication such as a machine-type communication (MTC) device.

A base station (BS) is generally a fixed station that communicates with the wireless device, and may be referred to as another terminology, such as an evolved-NodeB (eNB), a base transceiver system (BTS), an access point, etc.

Hereinafter, it is described that the present invention is applied according to a 3rd generation partnership project (3GPP) long term evolution (LTE) based on 3GPP technical specification (TS). However, this is for exemplary purposes only, and thus the present invention is also applicable to various wireless communication networks.

In a carrier aggregation (CA) environment or a dual connectivity environment, the wireless device may be served by a plurality of serving cells. Each serving cell may be defined with a downlink (DL) component carrier (CC) or a pair of a DL CC and an uplink (UL) CC.

The serving cell may be classified into a primary cell and a secondary cell. The primary cell operates at a primary frequency, and is a cell designated as the primary cell when an initial network entry process is performed or when a network re-entry process starts or in a handover process. The primary cell is also called a reference cell. The secondary cell operates at a secondary frequency. The secondary cell may be configured after an RRC connection is established, and may be used to provide an additional radio resource. At least one primary cell is configured always. The secondary cell may be added/modified/released by using higher-layer signaling (e.g., a radio resource control (RRC) message).

A cell index (CI) of the primary cell may be fixed. For example, a lowest CI may be designated as a CI of the primary cell. It is assumed hereinafter that the CI of the primary cell is 0 and a CI of the secondary cell is allocated sequentially starting from 1.

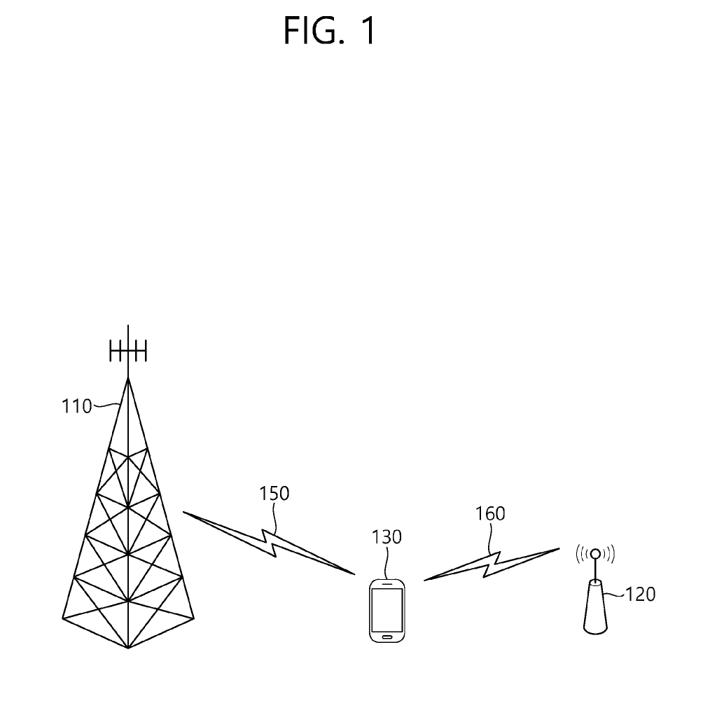

FIG. 1 shows an example of an LTE service using an unlicensed band.

A wireless device 130 establishes a connection with a 1st BS 110, and receives a service through a licensed band. For traffic offloading, the wireless device 130 may receive a service through an unlicensed band with respect to a 2nd BS 120.

The 1st BS 110 is a BS supporting an LTE system, whereas the 2nd BS 120 may also support other communication protocols such as a wireless local area network (WLAN) in addition to LTE. The 1st BS 110 and the 2nd BS 120 may be associated with a carrier aggregation (CA) environment, and a specific cell of the 1st BS 110 may be a primary cell. Alternatively, the 1st BS 110 and the 2nd BS 120 may be associated with a dual connectivity environment, and a specific cell of the 1st BS 110 may be a primary cell. In general, the 1st BS 110 having the primary cell has wider coverage than the 2nd BS 120. The 1st BS 110 may be called a macro cell. The 2nd BS 120 may be called a small cell, a femto cell, or a micro cell. The 1st BS 110 may operate the primary cell and zero or more secondary cells. The 2nd BS 120 may operate one or more secondary cells. The secondary cell may be activated/deactivated by an indication of the primary cell.

The above description is for exemplary purposes only. The 1st BS 110 may correspond to the primary cell, and the 2nd BS 120 may correspond to the secondary cell, so that the cell can be managed by one BS.

The licensed band is a band in which an exclusive use is guaranteed to a specific communication protocol or a specific provider.

The unlicensed band is a band in which various communication protocols coexist and a shared use is guaranteed. The unlicensed band may include 2.5 GHz and/or 5 GHz band used in a WLAN.

It is assumed in the unlicensed band that a channel is occupied basically through contention between respective communication nodes. Therefore, in communication in the unlicensed band, it is required to confirm that signal transmission is not achieved by other communication nodes by performing channel sensing. For convenience, this is called a listen before talk (LBT), and if it is determined that signal transmission is not achieved by other communication nodes, this case is defined as confirmation of clear channel assessment (CCA).

The LBT must be performed preferentially in order for a BS or wireless device of an LTE system to have access to a channel in the unlicensed band. Further, when the BS or wireless device of the LTE system transmits a signal, an interference problem may occur since other communication nodes such as the WLAN or the like also perform the LBT. For example, in the WLAN, a CCA threshold is defined as −62 dBm as to a non-WLAN signal and is defined as −82 dBm as to a WLAN signal. This means that interference may occur in an LTE signal due to other WLAN devices when the LTE signal is received with power less than or equal to −62 dBm.

Hereinafter, when it is said that ‘LBT is performed’ or ‘CCA is performed’, it implies that whether a channel is idle or is used by another node is confirmed first and thereafter the channel is accessed.

Hereinafter, the LTE and the WLAN are described for example as a communication protocol used in the unlicensed band. This is for exemplary purposes only, and thus it may also be said that a 1st communication protocol and a 2nd communication protocol are used in the unlicensed band. ABS supports the LTE. A UE is a device supporting the LTE.

Hereinafter, although it is described that downlink (DL) transmission is based on transmission performed by a BS and uplink (UL) transmission is based on transmission performed by a UE, the DL transmission and the UL transmission may also be performed by a transmission node or node group in a wireless network. The UE may imply an individual node which exists for each user, and the BS may imply a central node for transmitting/receiving and controlling data for a plurality of individual nodes. From this perspective, the term ‘BS’ may be replaced with a DL node, and the term ‘UE’ may be replaced with a UL node.

Hereinafter, a cell (or a carrier) operating in an unlicensed band is called an unlicensed cell or an unlicensed carrier. A cell operating in a licensed band is called a licensed cell or a licensed carrier.

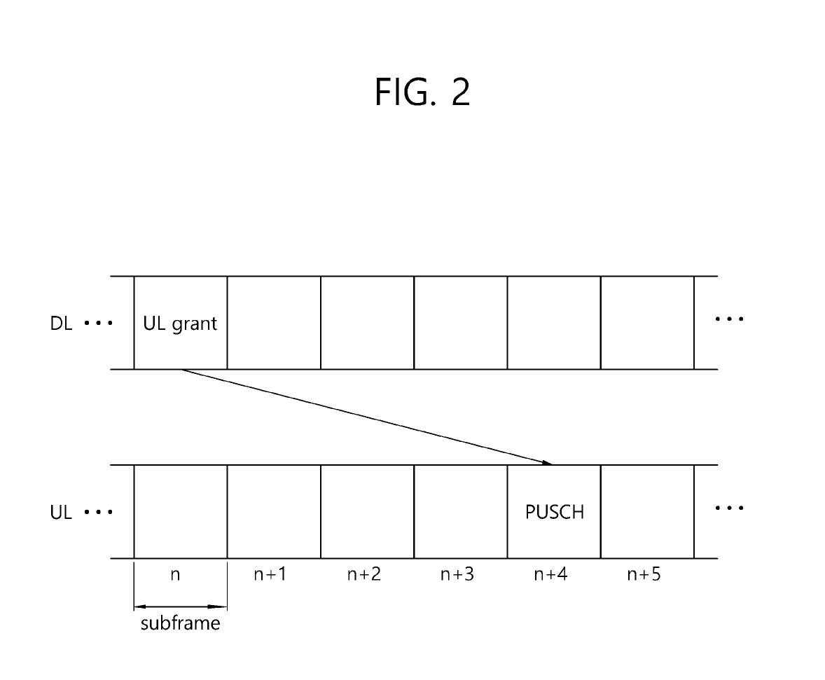

FIG. 2 shows an example of UL transmission in 3GPP LTE.

This is an example of a 3GPP LTE frequency division duplex (FDD) in which a DL carrier and a UL carrier occupy different bands. In the 3GPP LTE, scheduling is performed in unit of subframes. The subframe includes a plurality of orthogonal frequency division multiplexing (OFDM) symbols, and a time required to transmit one subframe is called a transmission time interval (TTI). 1 TTI may be 1 ms. Since the 3GPP LTE uses orthogonal frequency division multiple access (OFDMA) in a downlink (DL), the OFDM symbol is only for expressing one symbol period in a time domain, and there is no limitation in a multiple access scheme or terminologies. For example, the OFDM symbol may also be referred to as another terminology such as a single carrier-frequency division multiple access (SC-FDMA) symbol, a symbol period, etc.

First, a UE receives a UL grant from a BS in a subframe n. The UL grant includes information regarding resource allocation for UL transmission. The UL grant may be received on a physical downlink control channel (PDCCH) which is a DL control channel of the 3GPP LTE.

The UE transmits UL data on a physical uplink shared channel (PUSCH) in accordance with the UL grant in a subframe n+4. The PUSCH is a UL data channel of the 3GPP LTE.

In typical mobile wireless communication such as the 3GPP LTE, UL transmission is performed in accordance with a reference timing. There is no problem if a UL carrier is defined in a licensed band in which an exclusive usage is guaranteed. However, if the UL carrier is defined in an unlicensed band, UL transmission may not be achieved at a determined reference timing since a radio channel is occupied by another device.

Hereinafter, it is proposed a method for acquiring an equal access occasion while avoiding collision with another device when a wireless node such as a UE performs a CCA operation in an unlicensed band.

Hereinafter, the reference timing is a time point at which DL transmission or UL transmission starts, and may be, for example, a subframe boundary. The UE may perform the CCA during a specific duration prior to the reference timing.

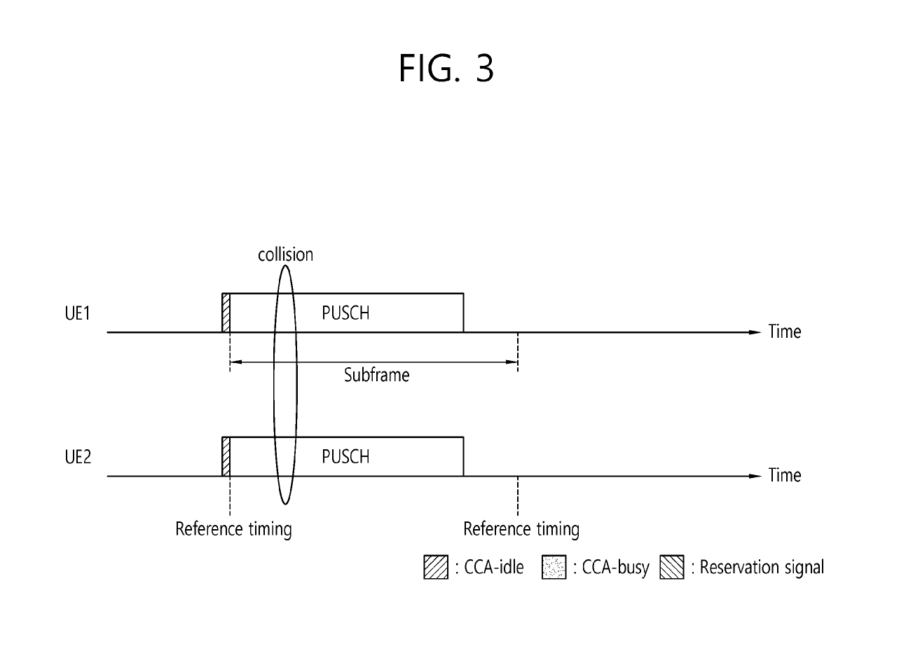

FIG. 3 shows an example of UL transmission in an unlicensed band.

It is assumed that a UE1 and a UE2 use the same UL carrier, and the same reference timing is used for UL transmission of the UE1 and the UE2. That is, it is assumed that the same subframe start point is used for UL transmission of the UE1 and the UE2. That is, the same reference timing is used for UL transmission of the UE1 and the UE2. If the UE1 and the UE2 start CCA at the same time point, both the UE1 and the UE2 start transmission of a PUSCH simultaneously by determining that a channel is idle, which may result in occurrence of collision.

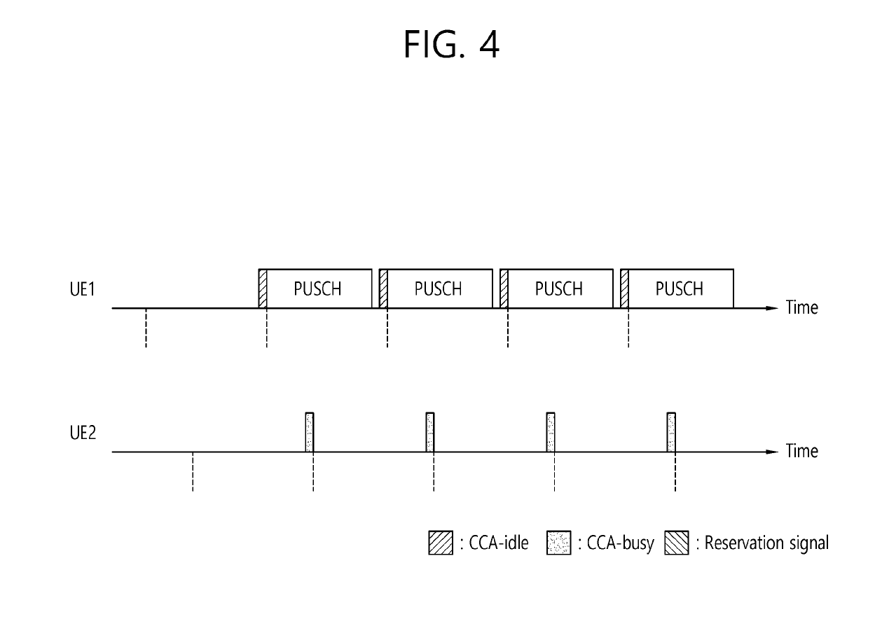

FIG. 4 shows another example of UL transmission in an unlicensed band.

This is a case where a UE1 and a UE2 have a different timing. The UE2 starts CCA at a later time than the UE1. If the UE1 continuously performs UL transmission, the UE2 may recognize that a channel is always busy, and thus may not have an occasion to have access to a UL channel.

In the following embodiment, UL transmission performed by different UEs is described for example. However, the present embodiment may also be applied to UL transmission in a plurality of UL cells managed by one UE and DL transmission in a plurality of DL cells managed by one BS.

The CCA may be performed during a specific duration, and a minimum duration in which the CCA is performed may be called a CCA slot. A window in which the CCA can be performed is called a CCA window. The BS/UE may start the CCA within the CCA window. A point at which the CCA starts within the CCA window is called a CCA start. The CCA window may be defined for every subframe or every reference timing. Alternatively, the CCA window may be defined for each pre-determined period (e.g., multiple times of a subframe). This period is called a CCA period. Upon detecting a CCA idle, UL transmission or DL transmission may be performed during one or more subframes.

For the reference timing and/or the CCA start for transmission in the unlicensed band, an offset against a timing of a licensed cell may be given for each UE or for each unlicensed cell. The offset value may include a subframe offset or a time offset. Information regarding the offset value may be provided by the BS to the UE.

The BS or the UE may determine a period/size of the CCA window, a size of a CCA duration, and/or a CCA start on the basis of a seed value. The seed value may be a cell ID, a UE ID, time information (a subframe index, a radio frame index, etc.), and/or a pre-defined parameter. Information regarding the seed value may be provided by the BS to the UE.

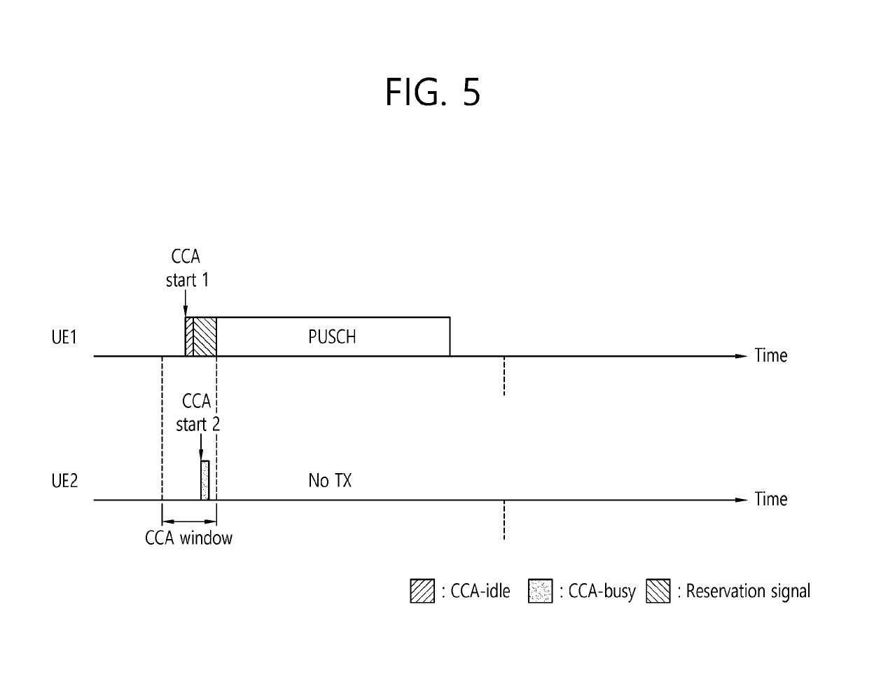

FIG. 5 shows UL transmission according to an embodiment of the present invention.

A CCA start for each UE is determined for each UE within a CCA window. The UE may determine the CCA start either randomly or on the basis of a seed value.

Upon confirming a CCA idle at a first CCA start, a UE1 starts UL transmission in accordance with a reference timing. A PUSCH may be transmitted through all or some of OFDM symbols in a subframe. However, before UL transmission starts after the CCA idle, the UE1 may transmit a reservation signal to prevent another UE from detecting the CCA idle. The reservation signal may be any signal for allowing the UE1 to occupy a radio channel.

Upon confirming a CCA busy at a second CCA start, a UE2 may discard transmission, or may delay transmission to a next reference timing.

The BS may provide the UE with information regarding the CCA start. Alternatively, the BS may provide information regarding a maximum length of the reservation signal in the UE. The UE may start the CCA from a time immediately before the maximum length of the reservation signal. Information regarding the CCA start/reservation signal may be included in a UL grant or may be transmitted through a medium access control (MAC)/radio resource control (RRC) message.

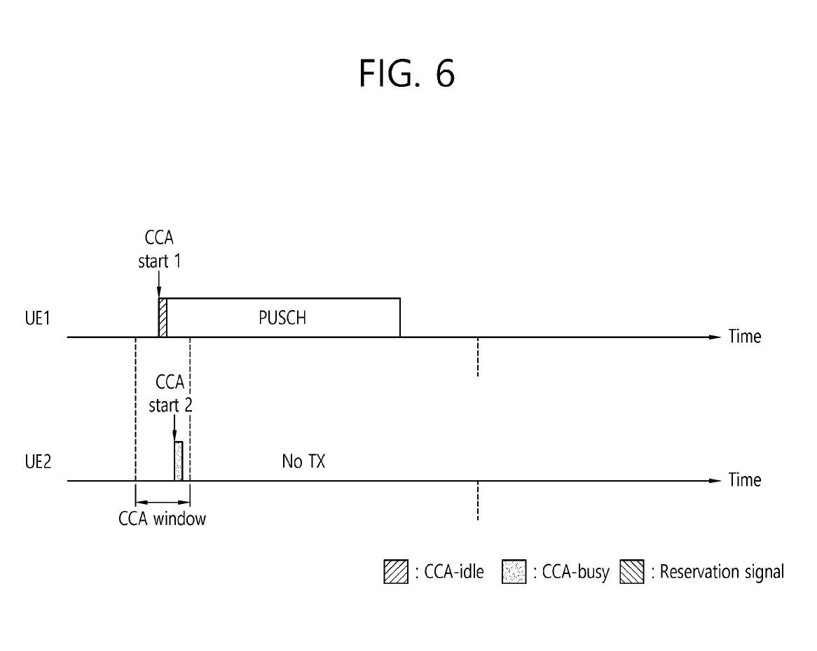

FIG. 6 shows UL transmission according to another embodiment of the present invention.

In comparison with the embodiment of FIG. 5, a UE1 immediately performs UL transmission upon confirming a CCA idle. The UE1 does not have to transmit a reservation signal.

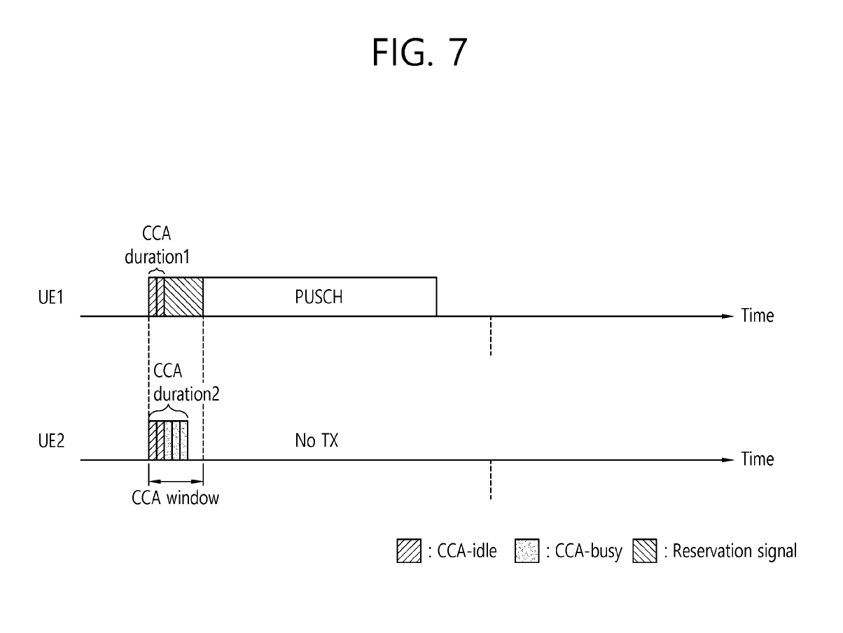

FIG. 7 shows UL transmission according to another embodiment of the present invention.

A CCA start is identical for all UEs, but has a different length of a CCA duration. The CCA duration may be defined as a multiple of a CCA slot. The UE may start a channel access when a CCA idle is confirmed in the entire CCA duration. Alternatively, the UE may start a channel access when the CCA idle is confirmed in a first slot and last slot in the CCA duration.

The UE may start the channel access when the CCA idle is confirmed in the first CCA slot corresponding to the CCA start and the last CCA slot randomly acquired.

Upon confirming the CCA idle, the UE1 starts UL transmission in accordance with a reference timing. However, before UL transmission starts after the CCA idle, the UE1 may transmit a reservation signal to prevent another UE from detecting the CCA idle. The reservation signal may be any signal for allowing the UE1 to occupy a radio channel.

The BS may provide the UE with information regarding the CCA duration. The information regarding the CCA duration may be included in a UL grant or may be transmitted through a MAC/RRC message.

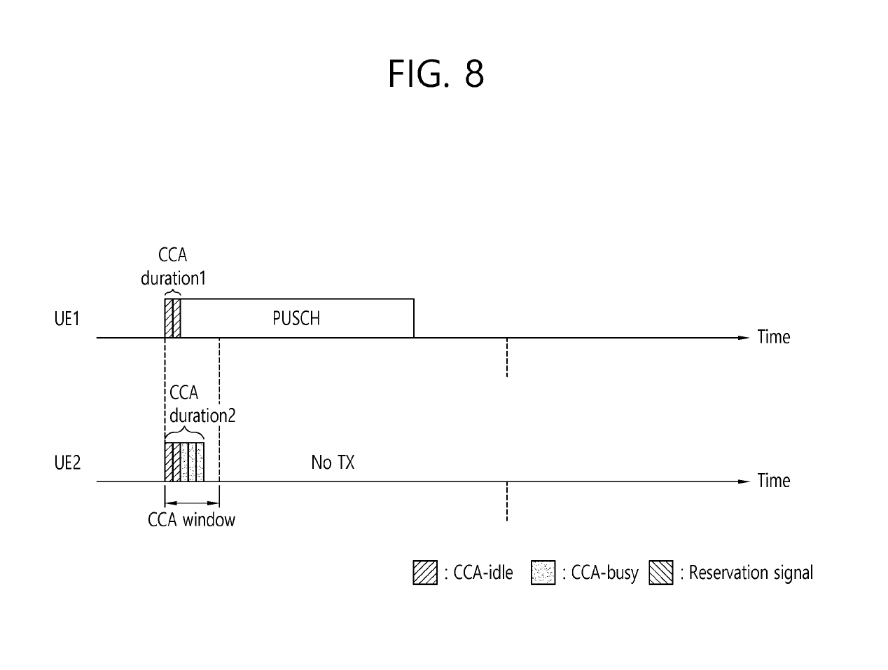

FIG. 8 shows UL transmission according to another embodiment of the present invention.

In comparison with the embodiment of FIG. 7, a UE1 immediately performs UL transmission upon confirming a CCA idle. The UE1 does not have to transmit a reservation signal.

A CCA start, a CCA duration, and/or a reference timing may vary over time. A period/offset for changing the reference timing may be randomly determined or may be fixed.

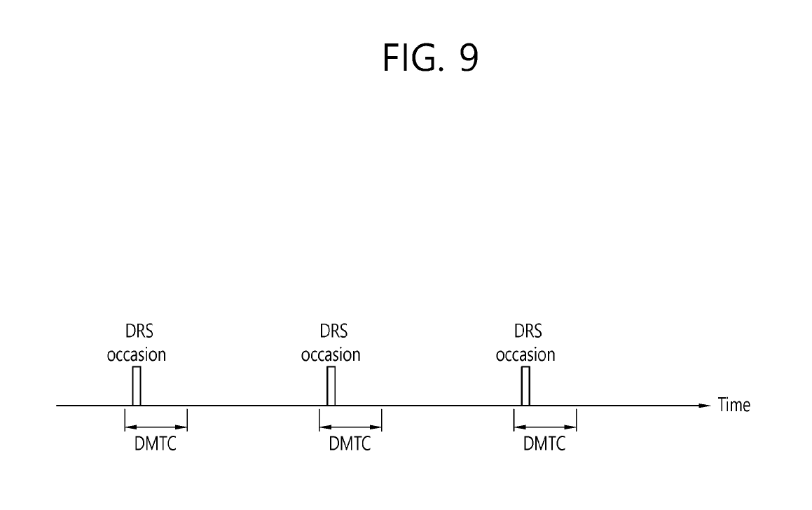

FIG. 9 shows signal transmission according to an embodiment of the present invention.

A discovery signal (DRS) may be transmitted at each pre-determined timing in an unlicensed cell. The DRS may be used in DL synchronization, measurement, and cell identification. A duration in which transmission of the DRS is possible is called a DRS measurement timing configuration (DMTC). A duration in which the DRS is transmitted in the DMTC duration is called a DRS occasion.

If the DRS occasion persistently overlaps between different BSs, an unequal channel access may occur. To prevent this, the following method is proposed.

In one embodiment, the BS may determine a timing of the DMTC duration in accordance with a DRS pattern for each cell. The DMTC timing is a radio frame number, a subframe number or subframe offset, or a symbol number or symbol offset at which the DMTC duration starts.

In another embodiment, a timing of the DRS occasion in the DMTC duration may be determined in accordance with a DRS pattern for each cell.

The BS may provide the UE with the DRS pattern for a cell to which the UE has access or information regarding the DRS pattern for a neighboring cell to be found by the UE.

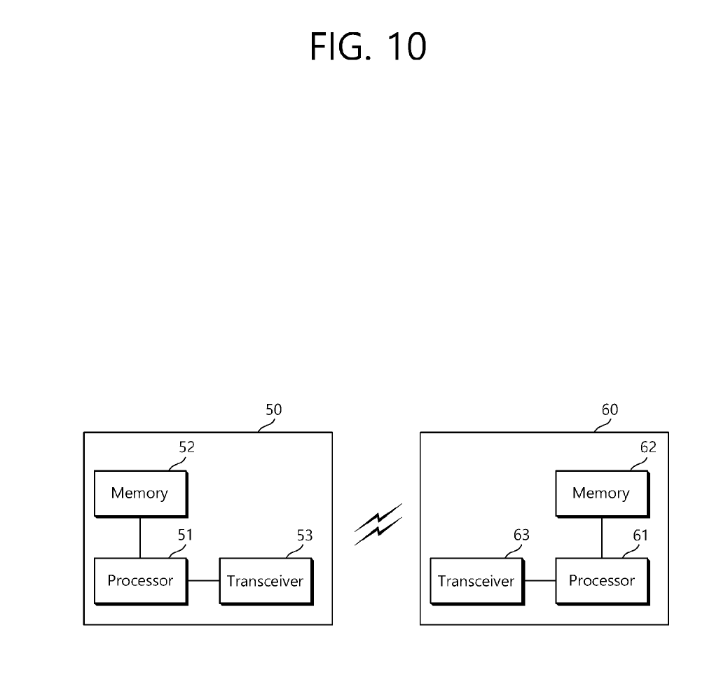

FIG. 10 is a block diagram showing a wireless communication system according to an embodiment of the present invention.

A wireless device 50 includes a processor 51, a memory 52, and a transceiver 53. The memory 52 is coupled to the processor 51, and stores various instructions executed by the processor 51. The transceiver 53 is coupled to the processor 51, and transmits and/or receives a radio signal. The processor 51 implements the proposed functions, procedures, and/or methods. In the aforementioned embodiment, an operation of the UE may be implemented by the processor 51. When the aforementioned embodiment is implemented with a software instruction, the instruction may be stored in the memory 52, and may be executed by the processor 51 to perform the aforementioned operation.

A BS 60 includes a processor 61, a memory 62, and a transceiver 63. The BS 60 may operate in an unlicensed band. The memory 62 is coupled to the processor 61, and stores various instructions executed by the processor 61. The transceiver 63 is coupled to the processor 61, and transmits and/or receives a radio signal. The processor 61 implements the proposed functions, procedures, and/or methods. In the aforementioned embodiment, an operation of the BS may be implemented by the processor 61.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for uplink transmission in an unlicensed band, the method comprising:
determining, by a wireless device, a clear channel assessment (CCA) start within a CCA window to perform CCA in the unlicensed band;
confirming, by the wireless device, whether a channel is idle by performing the CCA from the CCA start in the unlicensed band; and
transmitting, by the wireless device, uplink data if the channel is idle.

2. The method of claim 1, wherein the uplink data is transmitted based on a reference timing determined in accordance with an uplink timing in a licensed band.

3. The method of claim 2, wherein the reference timing comprises a subframe boundary.

4. The method of claim 2, wherein the CCA start is determined randomly.

5. The method of claim 2, wherein the CCA start is determined based on an identifier of the wireless device or an identifier of a cell in which the uplink data is transmitted.

6. The method of claim 2, further comprising:
transmitting a reservation signal for occupying the channel until the uplink data is transmitted after confirming that the channel is idle.

7. The method of claim 1, wherein the wireless device performs the CCA during a CCA duration from the CCA start to confirm whether the channel is idle.

8. The method of claim 7, wherein the CCA duration comprises a plurality of CCA slots, and the wireless device determines that the channel is idle if the channel is idle at first and last CCA slots among the plurality of CCA slots.

9. A device in a wireless communication system, the device comprising:
a transceiver configured to transmit and receive a radio signal; and
a processor operatively coupled to the transceiver and configured to:
determine a clear channel assessment (CCA) start within a CCA window to perform CCA in the unlicensed band;
confirm whether a channel is idle by performing the CCA from the CCA start in the unlicensed band; and
transmit uplink data through the transceiver if the channel is idle.

10. The apparatus of claim 9, wherein the uplink data is transmitted based on a reference timing determined in accordance with an uplink timing in a licensed band.

11. The apparatus of claim 10, wherein the CCA start is determined randomly.

12. The apparatus of claim 10, wherein the CCA start is determined based on an identifier of the device or an identifier of a cell in which the uplink data is transmitted.

13. The apparatus of claim 10, wherein the processor is configured to transmit a reservation signal for occupying the channel through the transceiver until the uplink data is transmitted after confirming that the channel is idle.
